(19) United States
(12) Patent Application Publication
(10) Pub. No.: US 2007/0185683 A1
(43) Pub. Date: Aug. 9, 2007

(54) Method and system for deriving time-dependent dielectric breakdown lifetime

(76) Inventors: Eu Gene Glen Foo, Singapore (SG); Yong Han Frankie Low, Singapore (SG)

Correspondence Address: GALLAGHER & LATHROP, A PROFESSIONAL CORPORATION, 601 CALIFORNIA ST, SUITE 1111, SAN FRANCISCO, CA, 94108, US

(21) Appl. No.: 11/352,460

(22) Filed: Feb. 9, 2006

(51) Int. Cl. G06F 19/00

(52) U.S. Cl. 702/181

(57) ABSTRACT

A method and system for deriving Time Dependent Dielectric Breakdown (TDDB) lifetime of a batch of semiconductor devices, the method comprising, defining a qualifying criteria based on past measurement data; measuring at least one parameter of one or more semiconductor devices representative of the batch; comparing said at least one parameter against the qualifying criteria; and if said at least one parameter qualifies according to the qualifying criteria, deriving the TDDB lifetime for the batch based on the past measurement data and an electrical measurement of the semiconductor devices.

### FIELD OF INVENTION

The present invention relates broadly to a method of deriving Time Dependent Dielectric Breakdown (TDDB) lifetime of a batch of semiconductor devices, to a computer readable data storage medium having stored thereon computer code means for instructing a computer processor to execute a method of deriving Time Dependent Dielectric Breakdown (TDDB) lifetime for one or more semiconductor devices and to a system for deriving Time Dependent Dielectric Breakdown (TDDB) lifetime of a batch of semiconductor devices.

### BACKGROUND

During semiconductor device manufacturing, determining the Time Dependent Dielectric Breakdown (TDDB) lifetime of each batch of wafers typically provides a representative measure of reliability relating to the batch of wafers. The TDDB lifetime is typically determined by sampling a number of devices from the wafers.

During determination of the TDDB lifetime using stress conditions, at least two different stress voltage biases are typically applied to separate sets of samples respectively and at a relatively higher temperature to obtain gate oxide breakdown of each sample. Gate oxide breakdown typically occurs when there is an increase of about 20% in measured gate current The values of the different stress voltages are typically chosen so that a straight line can be obtained when plotting a so-called V-model (gate-voltage dependent lifetime model) graph in later stages of the TDDB lifetime analysis process. When gate oxide breakdown occurs, the time to fail (TTF) of each sample is measured and recorded at the particular stress voltage bias. The TTFs are then typically arranged in ascending order and. plotted into a set of cumulative TDDB distribution graphs for the different stress voltage biases using a Weibull distribution equation.

After obtaining the cumulative TDDB distribution graphs, the V-model graph is typically plotted using data points based on a percentile point extracted from each of the TDDB distributions graphs. The V-model graph is then typically extrapolated and area-scaling is performed on the V-model graph such that the TDDB lifetime at a selected worst case use condition may be determined.

However, by adopting the above existing methods, one disadvantage may arise as measuring the TTFs for relatively low stress voltage bias values typically takes up to two weeks. This timeframe may be too long for the manufacturing facilities.

Furthermore, another disadvantage may arise that since the samples have to be stressed to failure at each different voltage bias, a relatively large number of samples per wafer batch are typically destroyed during the TDDB lifetime analysis process. Typically, at least two samples are stressed to failure for each voltage bias so that a set of straight-line cumulative TDDB distribution graphs may be plotted based on a fail fraction in the Weibull distribution equation. It will be appreciated that if more samples are stressed to failure and their data used in the Weibull distribution equation, the set of straight-line cumulative TDDB distribution graphs plotted will be more reliable.

Hence, there exists a need for a method of determining TDDB lifetime to address at least one of the above disadvantages.

### SUMMARY

In accordance with a first aspect of the present invention, there is provided a method of deriving Time Dependent Dielectric Breakdown (TDDB) lifetime of a batch of semiconductor devices, the method comprising, defining a qualifying criteria based on past measurement data; measuring at least one parameter of one or more semiconductor devices representative of the batch; comparing said at least one parameter against the qualifying criteria; and wherein, if said at least one parameter qualifies according to the qualifying criteria, the TDDB lifetime for the batch is derived based on the past measurement data and an electrical measurement of the semiconductor devices.

The qualifying criteria may be based on gate current measurements.

The qualifying criteria may be defined based on stress conditions and said at least one parameter may be measured under said stress conditions.

The stress conditions may be chosen from a range of conditions satisfying a straight line behavior of a V-model graph of the past measurement data.

The stress conditions may comprise a voltage bias value of about −7.3V.

The stress conditions may comprise a temperature of about 125° C.

The deriving of the TDDB lifetime may be based on slopes of lifetime graphs of the past measurement data.

The deriving of the TDDB lifetime may be based on a mean value of said slopes of lifetime graphs of the past measurement data.

The deriving of the TDDB lifetime may be based on slopes of cumulative TDDB distribution graphs of the past measurement data.

The deriving of the TDDB may be based on a mean value of said slopes of cumulative TDDB distribution graphs of the past measurement data.

The extracting of the respective mean values may be based on a confidence level of about 95%.

In accordance with a second aspect of the present invention, there is provided a computer readable data storage medium having stored thereon computer code means for instructing a computer processor to execute a method of deriving Time Dependent Dielectric Breakdown (TDDB) lifetime for one or more semiconductor devices, the method comprising, defining a qualifying criteria based on past measurement data; measuring at least one parameter of one or more semiconductor devices representative of the batch; comparing said at least one parameter against the qualifying criteria; and wherein, if said at least one parameter qualifies according to the qualifying criteria, the TDDB lifetime for the batch is derived based on the past measurement data and an electrical measurement of the semiconductor devices.

In accordance with a third aspect of the present invention, there is provided a system for deriving Time Dependent Dielectric Breakdown (TDDB) lifetime of a batch of semiconductor devices, the system comprising a database for storing past measurement data; a first interface for inputting a qualifying criteria; a second interface for inputting least one parameter measurement of one or more semiconductor devices representative of the batch; a processor for comparing said inputted at least one parameter measurement against said inputted qualifying criteria; and if said at least one parameter measurement qualifies according to the qualifying criteria, the processor derives the TDDB lifetime for the batch based on the past measurement data and an electrical measurement of the semiconductor device

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1(a) is a typical TTF graph showing cumulative TDDB distribution graphs for three different voltage stress biases.

FIG. 1(b) is a typical lifetime graph showing a V-model graph and an area-scaled lifetime extrapolation.

FIG. 2(a) is a graph illustrating a normal distribution graph for the lifetime data points from six data sets in past measurement data in an example embodiment.

FIG. 2(b) is a graph showing a probability plot of a slope 1/k derived from the six data sets of FIG. 2(a) in the example embodiment.

FIG. 3(a) is a graph illustrating the cumulative TDDB distribution graphs for six data sets at the stress voltage bias of about −7.3V in the example embodiment.

FIG. 3(b) is a graph showing a probability plot of a slope B derived from FIG. 3(a) in the example embodiment.

FIG. 4 is a graph illustrating the probability plot for the lg′ for the past measurement data at the stress voltage bias of −7.3V in the example embodiment.

FIG. 5 is a graph illustrating typical lg′ characteristics of a semiconductor device when the device is stressed to obtain gate oxide breakdown.

FIG. 6 is a flowchart illustrating a method of deriving Time Dependent Dielectric Breakdown (TDDB) lifetime of a batch of semiconductor devices in the example embodiment.

FIG. 7 is a schematic drawing of a computer system for implementing a method in accordance with the example embodiment.

FIG. 8 is schematic drawing of a system for deriving Time Dependent Dielectric Breakdown (TDDB) lifetime of a batch of semiconductor devices in the example embodiment.

### DETAILED DESCRIPTION

In the following description, an introduction of an existing standard TDDB lifetime analysis method is first provided for better understanding. Subsequently, an example embodiment is described.

In the abovementioned existing analysis method, 24 samples are stressed at 125° C. at each of three different stress voltage biases of −7.3V, −6.9V and −6.5V until gate oxide breakdown occurs and the TTF for each sample is recorded. The temperature of 125° C. is chosen based on a typical “highest guaranteed product application temperature” of 125° C. for ten years. The stress voltage bias values are typically chosen so that a straight line graph may be obtained when the V-model graph is plotted at a later stage based on measured TTF values. Based on these stress voltage biases, a total of 72 samples are stressed to failure.

Using the recorded TTFs and the respective stress voltage biases, a Weibull distribution equation,
ln(t)=βln[−ln(1−F(t))]+ln α or
ln[−ln(1−F(t))]=[ln(t)]/β−[ln α]/β (1)

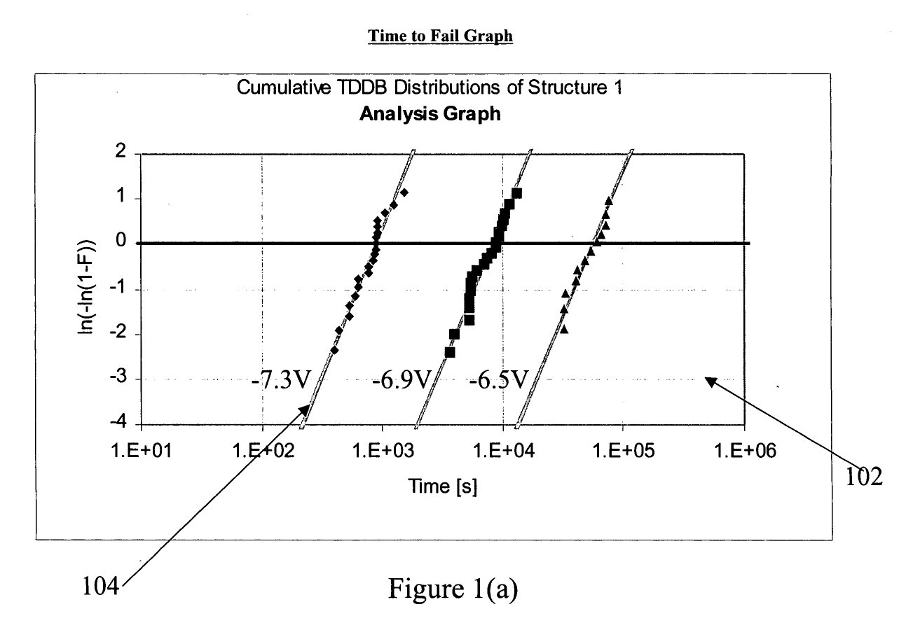

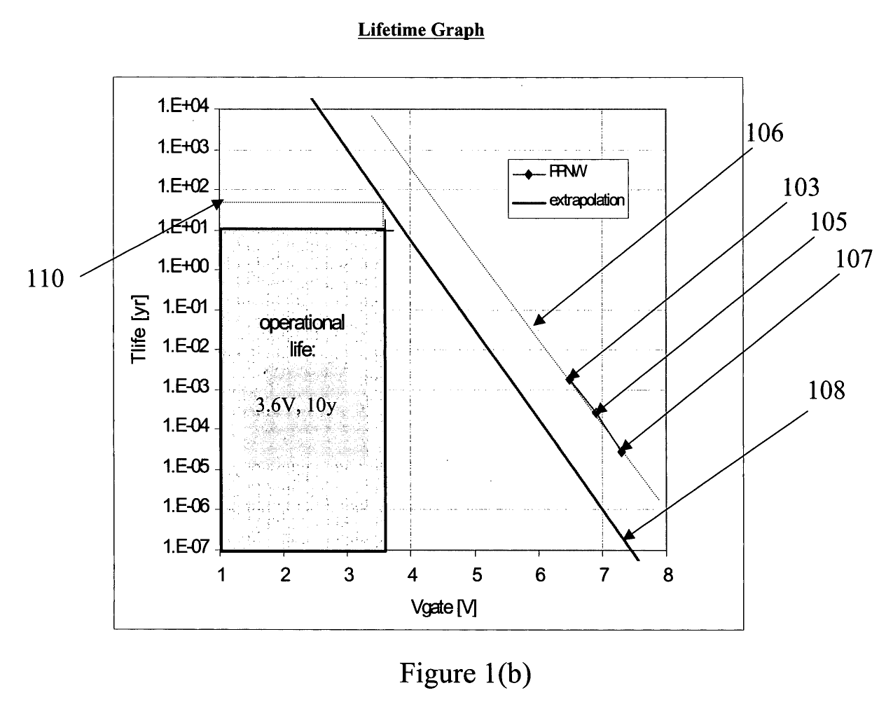

is typically used to plot a set of straight-line cumulative TDDB distribution graphs, in which ln[−ln(1−F(t))] is plotted as a function of [ln(t)]. The slope 1/β is termed the TTF slope B. In the Weibull equation above, t is the TTF of each sample, β is a shape parameter and a is a scale parameter or characteristic life. The fail fraction F is defined as F(t)=(i+1)/(N+2) where i is the ith position of each sample arranged in an ascending order of TTFs and N is the total number of samples tested to fail. FIG. 1(a) is a typical TTF graph 102 showing cumulative TDDB distribution graphs e.g. 104 for three different stress voltage biases. Table 1 below is an exemplary table listing samples with the TTFs arranged in ascending order.

TABLE 1
An example of a table listing TTFs in ascending order

| | Time to fail(s) | | |
|---|---|---|---|
| | arranged in | | |
| N | ascending order | F = (I + 1)/(N + 2) | ln[−ln(1 − F)] |
| 1 | 215.1 | =(1 + 1)/(22 + 2) = 0.083 | LN(−LN(1 − 0.083)) = |
| | | | −2.442 |
| 2 | 299.0 | =(2 + 1)/(22 + 2) = 0.125 | LN(−LN(1 − 0.125)) = |
| | | | −2.013 |
| 3 | 395.4 | And so on | −1.702 |
| 4 | 438.2 | And so on | −1.454 |
| 5 | 536.9 | And so on | −1.246 |
| 6 | 536.9 | And so on | −1.065 |
| 7 | 600.1 | And so on | −0.903 |
| 8 | 625.5 | And so on | −0.755 |
| 9 | 625.5 | And so on | −0.618 |
| 10 | 768.4 | And so on | −0.489 |
| 11 | 768.4 | And so on | −0.367 |
| 12 | 842.8 | And so on | −0.248 |
| 13 | 863.7 | And so on | −0.133 |
| 14 | 884.4 | And so on | −0.019 |
| 15 | 884.4 | And so on | 0.094 |
| 16 | 884.4 | And so on | 0.209 |
| 17 | 917.2 | And so on | 0.327 |
| 18 | 917.2 | And so on | 0.450 |
| 19 | 917.2 | And so on | 0.583 |
| 20 | 1061.6 | And so on | 0.732 |
| 21 | 1236.8 | And so on | 0.910 |
| 22 | 1507.1 | And so on | 1.156 |

After obtaining the cumulative TDDB distribution graphs using the Weibull distribution equation, one of the ln[−ln(1−F(t))]-axis values along the respective graphs e.g. 104 for each bias is typically selected. The corresponding time-axis value is used in a lifetime model graph (or known as a V-model graph), in which the lifetime is plotted as a function of the gate voltage. As can be seen in FIG. 1(b), the points 103, 105, and 107 for the respective gate voltages lie substantially in a straight line when the lifetime axis is exponential.

The V-model is used to describe the resulting graph 106, and is typically defined as
T_{life}(V)=Tₒ×exp(V/k) (2)
Equation (2) may be manipulated into a straight-line form
ln(T_{life}(V))=V/k+ln(Tₒ) (3)
where T_{life}(V) is the extracted time-axis value, V is the corresponding stress voltage bias of the extracted time-axis value and ln(Tₒ) is a constant. ln this introduction of the existing analysis method, a 63-percentile value of the ln[−ln(1−F(t))]-axis is selected and the corresponding time-axis values are extracted for plotting the V-model graph 106.

Area scaling is carried out on the graph 106. The area scaling equations are
Area Scale(AS)=exp[(ln(A_{struct}/A_{pdt}))/β] (4)
FFc=exp[(ln(−ln(1−FF)))/β] (5)
where FF=0.1 and β is the shape parameter from equation (1), A_{struct} is the test structure area and A_{pdt} is the application structure area in a product. Each data point in the V-model graph 106 is scaled according to
T_{life},corr x=T_{lifex}×FFc×AS (6)
Where T_{life}, corr x is the resultant area-scaled lifetime data point and T_{lifex} stands for each data point from the V-model graph 106. Referring to FIG. 1(b), graph 108 illustrates the resultant lifetime graph.

The V-model graph 106 is typically area-scaled to a reference area of about 0.1 cm²(this is chosen to be the value of A_{pdt}. The lifetime 110 at the worst-case use-condition (ie. at 3.6V in this example) may be determined from the lifetime graph 108. In this particular illustration, 3.6V is referred to as the worst-case use condition but it will be appreciated that the use condition may vary according to different products and/or requirements.

As was mentioned in the Background section, it is observed that obtaining the TDDB using the existing technique as described above is very time consuming. For example, for the stress voltage bias of −6.5V, it may take up to about two weeks for failure to occur in the test oven. In addition, a total of 72 samples of a current batch are stressed to failure during this analysis.

Following the above description of the standard TDDB lifetime analysis method above, the example embodiment will now be described. The example embodiment provides a technique for obtaining the TDDB with measurement of fewer current batch samples and over a shorter time period.

The inventors have recognized, based on statistical approximations derived from past measurement data, that it is possible to expedite TDDB lifetime analysis of a current batch of wafers. Gate current measured for samples of the current batch at a single stress voltage bias is chosen as a qualifying parameter or criteria to determine if the recognized behavior of the past measurement data can be utilized to analyze TDDB lifetime of the current batch samples.

In the example embodiment, the past measurement data relates to N-doped poly-Si on P-doped well (NPPW) Input/Output transistor oxide (GO2), 0.14 μm technology plate capacitors in accumulation. The transistor oxide is about 7 nm in thickness and about 0.35 μm in channel length.

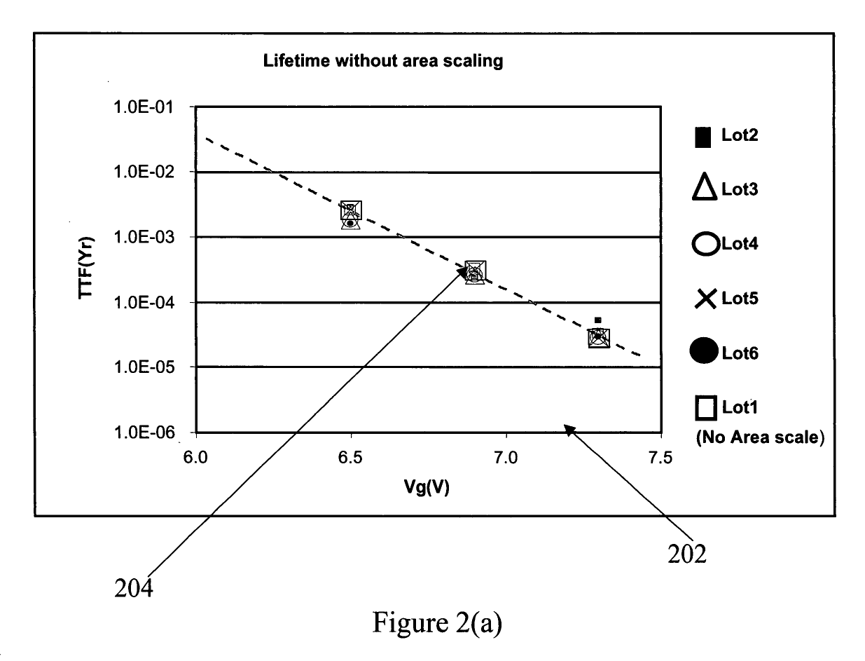

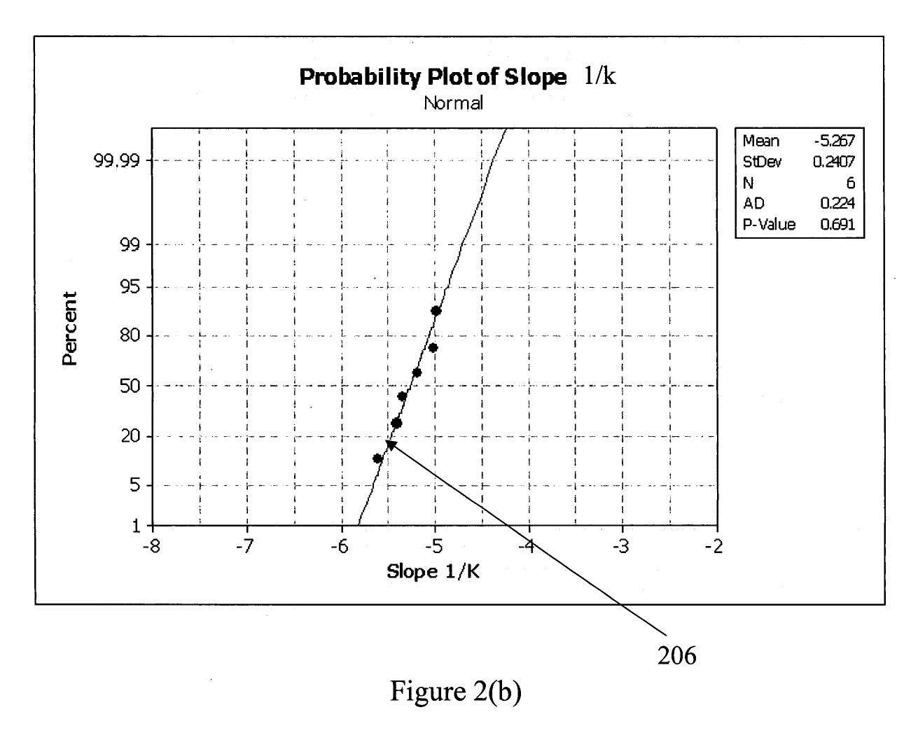

It has been recognized by the inventors that the slopes of lifetime graphs of the past measurement data (refer to 1/k from equation (3) or refer to the slope of graph 106 (FIG. 1(b))) followed a normal distribution with a significantly small sigma of 0.241, based on a 95% confidence level (CL). FIG. 2(a) shows the graph 202 illustrating the normal distribution graph for the lifetime data points e.g. 204 from six data sets in the past measurement data. FIG. 2(b) is a graph showing a probability plot 206 of the slope 1/k derived from the six data sets of FIG. 2(a). The mean value for 1/k extracted from the normal distribution is about −5.267.

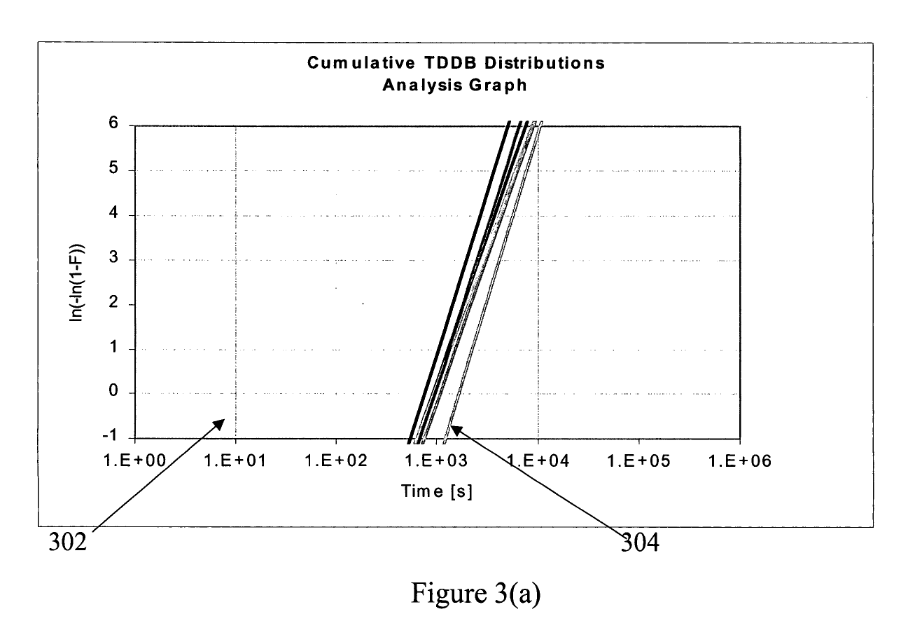

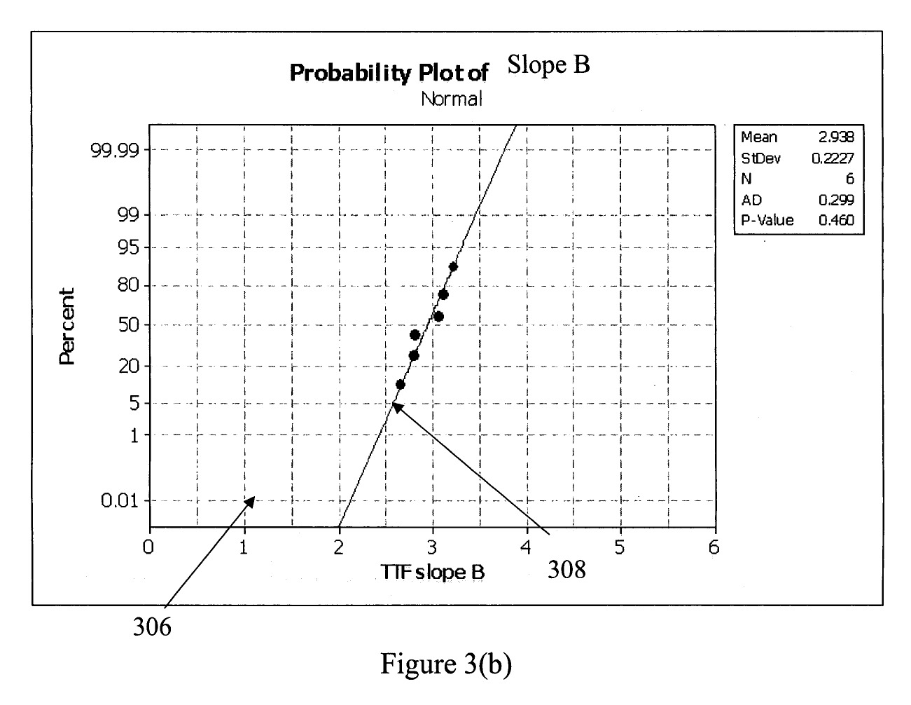

It has also been recognized by the inventors that the slopes of cumulative TDDB distribution graphs of the past measurement data, at respective stress voltage biases, (refer to B derived from equation (1) or refer to the slope of graph 104 (FIG. 1(a))) followed a normal distribution with a significantly small sigma value. For example, at a stress voltage bias of −7.3V, the corresponding slope B from the past measurement data follows a normal distribution with a mean value of about 2.94 and a significantly small sigma of 0.223 at a 95% CL. FIG. 3(a) is a graph 302 illustrating the cumulative TDDB distribution graphs e.g. 304 for six data sets at the stress voltage bias of about −7.3V. FIG. 3(b) is a graph 306 showing a probability plot 308 of the slope B derived from FIG. 3(a).

Further to the above, the inventors have also recognized that the gate current lg′ for different batches of wafers in the past measurement data at zero stress time (ie. the gate current at time=0 s) follows substantially a lognormal distribution. For example, at a stress voltage bias of about −7.3V at a temperature of 125° C., the lg′ at zero stress time follows a lognormal correlation of about 0.988.

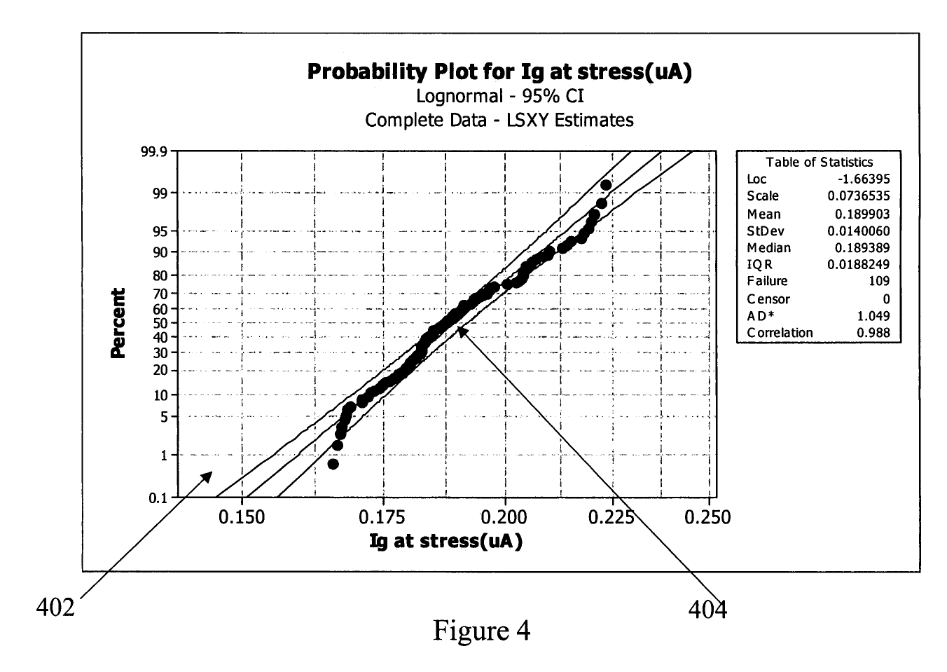

FIG. 4 is a graph 402 illustrating the probability plot 404 for the lg′ for the past measurement data at the stress voltage bias of −7.3V. The probability plot 404 is based on a lognormal distribution. The lg′ values are arranged in ascending order and the mathematical calculation of (i−0.3)/(N+0.4) is carried out where i is the ith position of each sample arranged in an ascending order of lg′ and N is the total number of samples measured. The results of the mathematical calculation gives the percent (x-axis) values in graph 402. From the plot 404, the lg′ range at a 95% CL is found to be around [0.165 μA to 0.223 μA]. This lg′ range is termed as the qualifying criteria for the example embodiment.

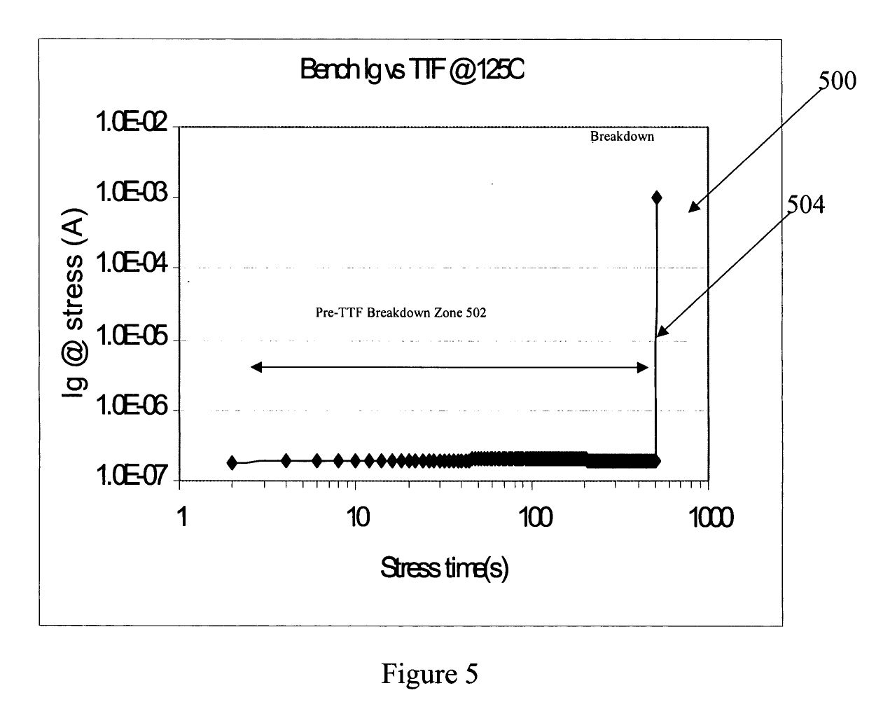

FIG. 5 is a graph 500 illustrating typical lg′ characteristics of a semiconductor device when the device is stressed to obtain gate oxide breakdown. As can be seen from FIG. 5, the pre-TTF breakdown zone 502 may extend to more than 100 s. Thus, although the qualifying criteria lg′ is measured at time=0 s, the lg′ may be measured at any time within the pre-TTF breakdown zone 502. Generally, it will be appreciated that an earlier, rather than later, lg′ measurement is preferred so that the measurement can stay clear of the actual breakdown region 504 for all samples.

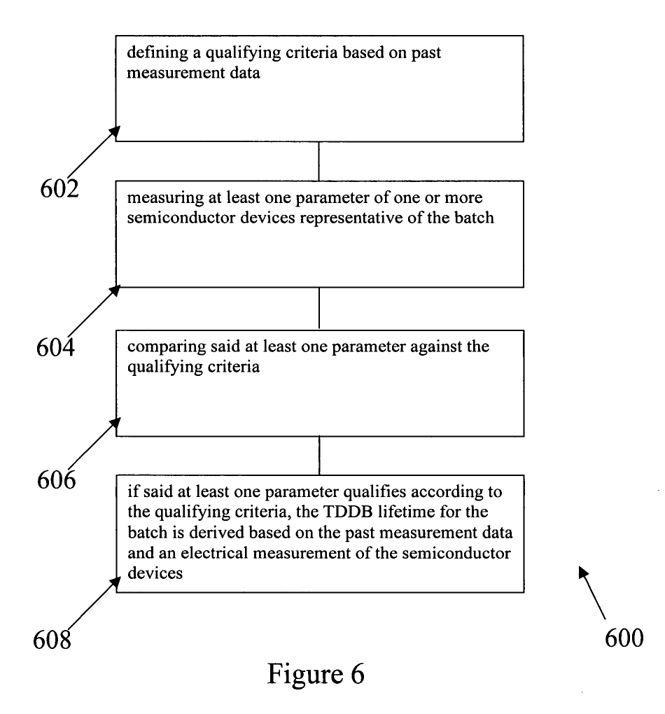

FIG. 6 is a flowchart 600 illustrating a method of deriving Time Dependent Dielectric Breakdown (TDDB) lifetime of a batch of semiconductor devices in the example embodiment. At step 602, a qualifying criteria based on past measurement data is defined. At step 604, at least one parameter of one or more semiconductor devices representative of the batch is measured. At step 606, the at least one parameter is compared against the qualifying criteria. At step 608, if the at least one parameter qualifies according to the qualifying criteria, the TDDB lifetime for the batch is derived based on the past measurement data and an electrical measurement of the semiconductor devices.

In the example embodiment described in more detail below, the TDDB lifetime analysis is carried out utilizing three gate oxide samples from a batch. A stress voltage bias of about −7.3V is applied to the three samples at a temperature of about 125° C. It is observed that at these stress conditions, it takes about 30 minutes for each gate oxide sample to break down. Therefore, if the stress voltage bias is applied to the three samples consecutively, it may take less than about 120 minutes to carry out TDDB lifetime analysis based on these three samples. In contrast to the existing analysis method where three stress voltage biases have to be utilized, the example embodiment uses only one stress voltage bias during the analysis process.

In the example embodiment, the gate currents of the samples during the pre-TTF breakdown zone time are measured at time=0 s, when the stress voltage bias of about −7.3V is first applied to each sample. The TTFs of the three samples are also recorded. A mean value lg′ of the three measured gate currents is then calculated and compared against the qualifying criteria of [0.165 μA to 0.223 μA].

If the mean value lg′ of the gate currents of these three samples is within the range of around [0.165 μA to 0.223 μA] (ie. qualifies according to the qualifying criteria), the TDDB lifetime of the samples is determined based on the inventors' recognitions above, and as described in more detail below.

Using the mean value of slope B of about 2.94 from the past measurement data and equations (4), (5), and (6), area-scaling is carried out on a mean value of the measured TTFs for the three samples.
Let the mean TTF value of the three samples be TTF′, equation (6) becomes:
   TTF′_{area connected}=TTF′×FFc×AS

Let TTF′_{area connected}=TTF″, a V-model graph is obtained based on TTF″ and using the lifetime slope mean (1/k) of about −5.267 from the past measurement data. Equation (3) can be re-written as,
ln(Tₒ)=ln(T_{life}_{_{area connected}}(V))−V/k (7)
By substituting the available values into equation (7), ln(Tₒ) can be calculated. Let the calculated value for ln(Tₒ) be A, for example a worst-case use condition at 3.6V can then be determined using equation (3) as,
T_{life}(at 3.6V use condition)=exp[(−5.267))3.6)+A] (8)

Thus, the TDDB lifetime of the batch can be derived based on equation (8).

As can be seen from the above description, the method in the example embodiment utilizes only one stress voltage bias as compared to three stress voltage biases when utilizing the existing analysis method. Also, the method of the example embodiment does not require plotting of cumulative TDDB distributions graphs using the Weibull distribution equation, as is required in the existing analysis method. Instead, the example embodiment uses a single mean TTF of the three samples together with two past measurement data slope values (ie. 1/k and B) to analyze the TDDB lifetime of the three samples.

Further to the above description, experimental data has been obtained by the inventors for verification. From a batch of wafers termed as Lot A, a set of 72 samples was extracted and analyzed using the standard TDDB lifetime analysis method on the one hand. On the other hand, two separate sets of three samples each from Lot A were extracted and analyzed using the method as described in the example embodiment.

For the analysis of these two sets of samples, the gate current lg at a stress voltage bias of about −7.3V for each sample was measured. The mean lg value of each set of samples was then calculated and compared to the qualifying criteria [0.165 μA to 0.223 μA]. The mean lg values qualified according to the qualifying criteria, and the mean value of the TTFs of each set of samples was then calculated using the TTF measurements. The mean value of the TTFs for each set of samples was then utilized with the statistical approximations derived from the past measurement data to determine the TDDB lifetime of the batch.

Table 2 and Table 3 below list experimental data for the two sets of samples respectively.

TABLE 2

| Lot ID | Ig at stress(−7.3 V), 125° C. | Sample data (TTF/s) |
|---|---|---|
| Lot A, W4 | 1.83E−07 | 470 |
| | 1.88E−07 | 416 |
| | 1.81E−07 | 478 |

TABLE 3

| Lot ID | Ig at stress(−7.3 V), 125° C. | Sample data (TTF/s) |
|---|---|---|
| Lot A, W5 | 1.89E−07 | 414 |
| | 1.85E−07 | 470 |
| | 1.80E−07 | 516 |

Table 4 list the results of the determined TDDB lifetime at the worst-case use condition at a voltage level of 3.6 V derived from the experimental data in Tables 2 and 3 respectively, using the method of the described example embodiment.

TABLE 4

| Lot ID | Vg | Use TTF(Y), Area scaled |
|---|---|---|
| Lot A, W4 | 3.6 | 38.1170228 |
| Lot A, W5 | 3.6 | 39.1230439 |

The derived TDDB lifetimes for Lot A based on the two sets of samples at the worst-case use condition of 3.6V were found to be about 38.117 years and 39.123 years respectively. On the other hand, using the standard TDDB lifetime analysis method, the TDDB lifetime at the worst-case use condition of Lot A was found to be about 37 years. Working on a tolerance level of 10%, the TDDB lifetimes derived using the example embodiment fall within a range of acceptable TDDB lifetime based of about [33.3 to 40.7] years around the value obtained from the standard methods.

In the example embodiment described above, advantageously, the TDDB lifetime test cycle is reduced to less than about 120 minutes as compared to the timeframe of up to two weeks taken by the existing method since only a single higher voltage bias is used. In addition to a reduction in analysis time, the example embodiment also reduces the number of samples stressed to failure as only three samples are used as compared to 72 samples used in existing analysis methods. Furthermore, the method of the example embodiment may also be advantageous over other analysis methods such as Electric-field Breakdown Dielectric (EBD) and Charge Breakdown Dielectric (QBD) where stress conditions (e.g. 125° C.) are typically not applied.

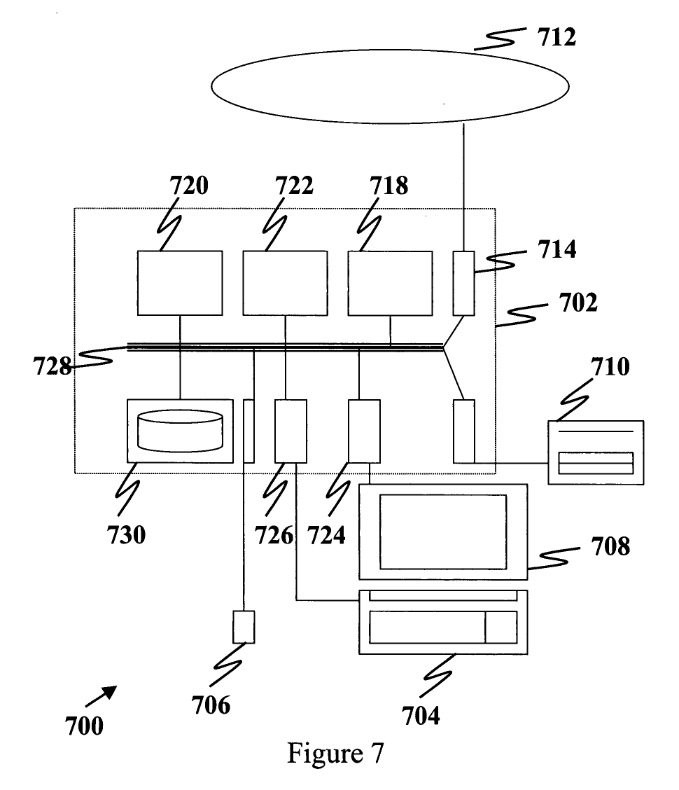

The method of the example embodiment can be implemented on a computer system 700, schematically shown in FIG. 7. It may be implemented as software, such as a computer program being executed within the computer system 700, and instructing the computer system 700 to conduct the method of the example embodiment.

The computer system 700 comprises a computer module 702, input modules such as a keyboard 704 and mouse 707 and a plurality of output devices such as a display 708, and printer 710.

The computer module 702 is connected to a computer network 712 via a suitable transceiver device 714, to enable access to e.g. the Internet or other network systems such as Local Area Network (LAN) or Wide Area Network (WAN).

The computer module 702 in the example includes a processor 718, a Random Access Memory (RAM) 720 and a Read Only Memory (ROM) 722. The computer module 702 also includes a number of Input/Output (I/O) interfaces, for example I/O interface 724 to the display 708, and I/O interface 727 to the keyboard 704.

The components of the computer module 702 typically communicate via and interconnected bus 728 and in a manner known to the person skilled in the relevant art.

The application program is typically supplied to the user of the computer system 700 encoded on a data storage medium such as a CD-ROM or floppy disk and read utilizing a corresponding data storage medium drive of a data storage device 730. The application program is read and controlled in its execution by the processor 718. Intermediate storage of program data maybe accomplished using RAM 720.

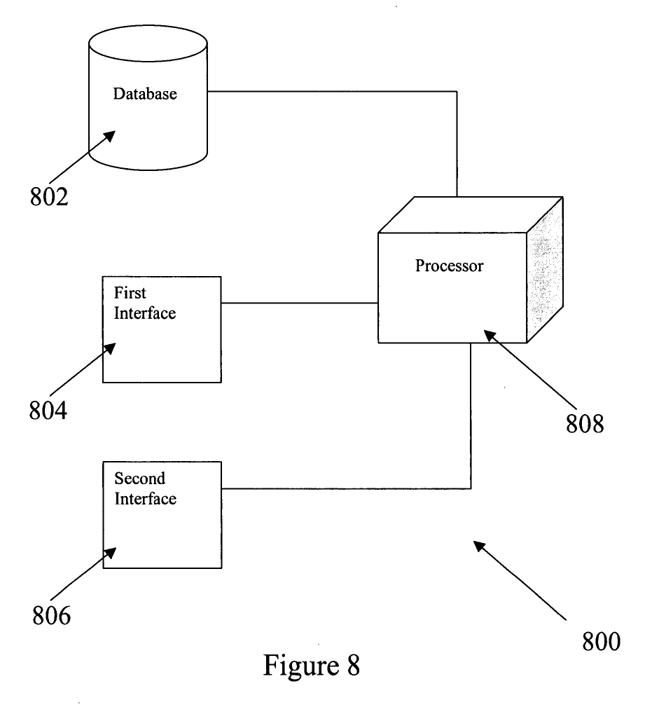

FIG. 8 is schematic drawing of a system 800 for deriving Time Dependent Dielectric Breakdown (TDDB) lifetime of a batch of semiconductor devices in the example embodiment. A database 802 for storing past measurement data is provided. A first interface 804 for inputting a qualifying criteria based on the past measurement data is also provided. A second interface 806 for inputting least one parameter measurement of one or more semiconductor devices representative of the batch is provided. A processor 808 for comparing said inputted at least one parameter measurement against said inputted qualifying criteria is next provided. The processor 808 is coupled to the database 802, to the first interface 804 and to the second interface 806. If said at least one parameter measurement qualifies according to the qualifying criteria, the processor 808 derives the TDDB lifetime for the batch based on the past measurement data and an electrical measurement of the semiconductor devices.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

In the example embodiment, although three samples were selected in order to obtain their measured gate currents and TTFs, it would be appreciated that the number of samples to be measured can range from one sample, two samples or more depending on the accuracy requirements desired.

Furthermore, although the stress voltage bias value is about −7.3V in the described example embodiment, other stress voltage bias values may be chosen. For example, on the one hand, using a higher stress voltage bias value may be more desirable in accelerating gate oxide breakdown and thus reducing time required, while on the other hand, the stress voltage bias value and/or other stress conditions are chosen from a range of conditions satisfying a straight line behavior of a V-model graph of the past measurement data (compare e.g. graph 106 (FIG. 1(b))). Also, the stress voltage bias value may be chosen based on whether or not a gate current qualifying criteria (compare e.g. FIG. 4) can be determined.

1. A method of deriving Time Dependent Dielectric Breakdown (TDDB) lifetime of a batch of semiconductor devices, the method comprising,
defining a qualifying criteria based on past measurement data;
measuring at least one parameter of one or more semiconductor devices representative of the batch;
comparing said at least one parameter against the qualifying criteria;
and if said at least one parameter qualifies according to the qualifying criteria,
deriving the TDDB lifetime for the batch based on the past measurement data and an electrical measurement of the semiconductor devices.

2. The method as claimed in claim 1, wherein the qualifying criteria is based on gate current measurements.

3. The method as claimed in claims 1 or 2, wherein the qualifying criteria is defined based on stress conditions and said at least one parameter is measured under said stress conditions.

4. The method as claimed in claim 3, wherein the stress conditions are chosen from a range of conditions satisfying a straight line behavior of a V-model graph of the past measurement data.

5. The method as claimed in claims 3 or 4, wherein the stress conditions comprise a voltage bias value of about −7.3V.

6. The method as claimed in any one of claims 3 to 5, wherein the stress conditions comprise a temperature of about 125° C.

7. The method as claimed in any one of claims 1 to 6, wherein the deriving of the TDDB lifetime is based on slopes of lifetime graphs of the past measurement data.

8. The method as claimed in claim 7, wherein the deriving of the TDDB lifetime is based on a mean value of said slopes of lifetime graphs of the past measurement data.

9. The method as claimed in any one of claims 1 to 8, wherein the deriving of the TDDB lifetime is based on slopes of cumulative TDDB distribution graphs of the past measurement data.

10. The method as claimed in claim 9, wherein the deriving of the TDDB lifetime is based on a mean value of said slopes of cumulative TDDB distribution graphs of the past measurement data.

11. The method as claimed in any one of claims 8 or 10, wherein the extracting of the respective mean values is based on a confidence level of about 95%.

12. A computer readable data storage medium having stored thereon computer code means for instructing a computer processor to execute a method of deriving Time Dependent Dielectric Breakdown (TDDB) lifetime of a batch of semiconductor devices, the method comprising,
defining a qualifying criteria based on past measurement data;
measuring at least one parameter of one or more semiconductor devices representative of the batch;
comparing said at least one parameter against the qualifying criteria;
and if said at least one parameter qualifies according to the qualifying criteria,
deriving the TDDB lifetime for the batch based on the past measurement data and an electrical measurement of the semiconductor devices.

13. A system for deriving Time Dependent Dielectric Breakdown (TDDB) lifetime of a batch of semiconductor devices, the system comprising,
a database for storing past measurement data;
a first interface for inputting a qualifying criteria based on the past measurement data;
a second interface for inputting least one parameter measurement of one or more semiconductor devices representative of the batch;
a processor for comparing said inputted at least one parameter measurement against said inputted qualifying criteria;
and if said at least one parameter measurement qualifies according to the qualifying criteria,
the processor derives the TDDB lifetime for the batch based on the past measurement data and an electrical measurement of the semiconductor devices.
